(19) United States
(12) Patent Application Publication
(10) Pub. No.: US 2026/0023297 A1
(43) Pub. Date: Jan. 22, 2026

(54) Time of Flight Light Direction and Ranging System

(71) Applicant: Apple Inc., Cupertino, CA (US)

(72) Inventors: Noel Axelrod, Mevaseret Zion (IL); Maoz Ovadia, Kiryat Ono (IL); Omer Korech, Pardes Hanna Karkur (IL); Boris Morgenstein, Tel Aviv (IL)

(21) Appl. No.: 18/776,461

(22) Filed: Jul. 18, 2024

(51) Int. Cl. G02F 1/29; G01S 7/481

(52) U.S. Cl. CPC G02F 1/292; G01S 7/4817

(57) ABSTRACT

A system for optical sensing, consisting of a transmitter that transmits outgoing collimated light toward a target along a transmit axis, and a receiver, positioned alongside the transmitter, that receives incoming light propagating from the target along a receive axis parallel to the transmit axis and that outputs electrical signals in response to the received incoming light. The system includes a switchable liquid crystal polarized grating (LCPG) positioned to intercept and divert, by a common angle, both the outgoing collimated light along the transmit axis and the incoming light along the receive axis, the common angle being selectable from among a plurality of preset diversion angles of the LCPG. A controller switches the LCPG over the preset diversion angles and processes the electrical signals output by the receiver in response to the incoming light received at the preset diversion angles so as to sense a property of the target.

### FIELD OF THE INVENTION

This invention relates generally to light direction and ranging (LIDAR) systems, and specifically to non-mechanical LIDAR systems.

### BACKGROUND OF THE INVENTION

A time of flight (ToF) system, using light, measures the time taken for light to travel from a transmitter to an object and return. From the known speed of light, the distance to the object can be calculated from the measured time. In order to measure the distance to multiple regions of the object, it may be necessary to alter the transmission direction, and mechanical means for changing the direction are known.

### SUMMARY OF THE INVENTION

An embodiment of the present invention provides a system for optical sensing, consisting of:
a transmitter, configured to transmit outgoing collimated light toward a target along a transmit axis;
a receiver, positioned alongside the transmitter and configured to receive incoming light propagating from the target along a receive axis parallel to the transmit axis and to output electrical signals in response to the received incoming light;
a switchable liquid crystal polarized grating (LCPG) positioned to intercept and divert, by a common angle, both the outgoing collimated light along the transmit axis and the incoming light along the receive axis, the common angle being selectable from among a plurality of preset diversion angles of the LCPG; and
a controller configured to switch the LCPG over the preset diversion angles and to process the electrical signals output by the receiver in response to the incoming light received at the preset diversion angles so as to sense a property of the target.

In a disclosed embodiment the transmitter consists of a single radiator that radiates light to a metasurface, and the metasurface is configured to produce the collimated light.

In a further disclosed embodiment the receiver consists of a single detector that receives light from a metasurface, and the metasurface is configured to focus the incoming light to the single detector.

In a yet further disclosed embodiment the switchable LCPG includes a passive polarization grating (PG) plate butted to a switchable liquid crystal (LC) plate configured to provide a switchable retardation to the outgoing collimated light and the incoming light. The switchable retardation may be one of a quarter-wave retardation and a three quarter-wave retardation. Alternatively, the switchable retardation may be one of a half-wave retardation and a zero retardation.

In an alternative embodiment the system includes a planar transparent plate having a first side, including a first metasurface configured to focus light to a detector in the receiver, and a second side, opposite the first side, including a second metasurface configured to form the outgoing collimated light in response to receiving light from a radiator in the transmitter.

In a further alternative embodiment the transmitter includes a plurality of separate radiators, each radiator being configured to radiate light to a metasurface, included in the transmitter, so as to produce the outgoing collimated light.

In a yet further alternative embodiment the receiver includes a plurality of separate detectors, each detector being configured to receive focused light from a metasurface, included in the receiver, configured to receive the incoming light.

The switchable LCPG include a plurality of switchable liquid crystal (LC) plates and the plurality of passive polarization grating (PG) plates, the LC plates and the PG plates being butted to each other in alternation.

The property of the target may include a distance of the target from the system.

There is also provided, according to an alternative embodiment of the present invention, a method for optical sensing, consisting of:
transmitting outgoing collimated light toward a target along a transmit axis;
receiving incoming light propagating from the target along a receive axis parallel to the transmit axis and outputting electrical signals in response to the received incoming light;
positioning a switchable liquid crystal polarized grating (LCPG) to intercept and divert, by a common angle, both the outgoing collimated light along the transmit axis and the incoming light along the receive axis, the common angle being selectable from among a plurality of preset diversion angles of the LCPG; and
switching the LCPG over the preset diversion angles and processing the electrical signals output by the receiver in response to the incoming light received at the preset diversion angles so as to sense a property of the target.

The present disclosure will be more fully understood from the following detailed description of the embodiments thereof, taken together with the drawings, in which:

### BRIEF DESCRIPTION OF THE DRAWINGS

FIG. 1 shows schematic diagrams of a Time of Flight, Light direction and ranging (ToF LIDAR) system, according to an embodiment of the present invention;

FIG. 2A is a schematic diagram of a cross-section of a grating assembly, according to an embodiment of the present invention;

FIG. 2B is a schematic diagram of a cross-section of a pair of plates that may be used to form other grating assemblies, according to an embodiment of the present invention;

FIG. 2C is a schematic diagram of an alternative grating assembly, according to an embodiment of the present invention;

FIG. 2D is a schematic diagram of a further alternative grating assembly, according to an embodiment of the present invention;

FIG. 3 shows schematic diagrams of a ToF system, according to an alternative embodiment of the present invention;

FIG. 4 shows schematic diagrams of a ToF system, according to a further alternative embodiment of the present invention; and

FIG. 5 shows schematic diagrams of a ToF system, according to a yet further alternative embodiment of the present invention.

### DETAILED DESCRIPTION OF EMBODIMENTS

### Overview

A time of flight light distance and ranging (ToF LIDAR) system measures the time taken for light to travel from a transmitter to a target and return, and calculates the distance to the target from the measured time. In order to measure the distance to multiple regions of the target, it is necessary to alter the transmission direction. Such a system may use mechanical means to alter the beam direction. However, this type of system has the disadvantage that the mechanical means may be complex.

Embodiments of the present invention avoid this problem and provide an efficient ToF LIDAR system that changes the beam direction non-mechanically.

The beam direction is changed by an electrically switched grating assembly that pairs switchable waveplates with polarization grating plates. The switchable waveplates are herein assumed to comprise liquid crystal (LC) plates. In a disclosed embodiment there is one pair of an LC plate and a polarization grating plate. The LC plate receives linearly polarized light, and generates either a right-hand circularly polarized beam or a left-hand circularly polarized beam, the handedness of the beam depending on the voltage applied to the plate. The associated polarization grating (PG) plate receives the polarized beam, and depending on the polarization direction diverts the beam into one of two angles. Other disclosed grating assemblies comprise more than one pair of LC and PG plates, and in one embodiment the grating assembly comprises four such pairs that are configured to provide 16 differently directed beams, the directions being selected according to the voltages applied to the LC plates.

The beam deflection applied by any given pair of LC and PG plates is reciprocal. In other words, the path followed by a transmitted beam from a transmitter to a target, as it traverses the pair, is the same as the path followed by the received beam as it traverses the pair and travels from the target to a beam receiver.

The beam reciprocity property applies to all the pairs of LC and PG plates in an electrically switched grating assembly, so that the TOF LIDAR system is able to use a single electrically switched grating assembly for the transmitted as well as for the received beam.

While some embodiments may use “lumped” optical components embodiments, e.g., glass or plastic lenses, other embodiments may use optical metasurfaces, also herein termed meta-optical elements (MOEs). An MOE has a planar structure composed of subwavelength-sized artificial features. In an embodiment of the system, one MOE is configured to collimate the transmitted light beam, and a second MOE is configured to focus the received light beam to a detector of the system.

Using an electrically switched grating assembly enables a ToF LIDAR system to be non-mechanical while still providing multiple directed beams. Using MOEs rather than glass or plastic lenses enables the TOF LIDAR system to be more compact.

### DETAILED DESCRIPTION

In the following description, like elements in the drawings are identified by like numerals, and like elements are differentiated as necessary by appending a letter to the identifying numeral. In addition, all directional references (e.g., upper, lower, upward, downward, left, right, top, bottom, above, below, vertical, and horizontal) are only used for identification purposes to aid the reader's understanding of the present invention, and do not create limitations, particularly as to the position, orientation, or use of embodiments of the invention.

In the description and in the claims, if rays of light are stated to be parallel, the rays are assumed to:
arrive from a location having a distance much further than, e.g., greater than a thousand times, an effective diameter of the receiving optics, or
have a source that is at a focal plane of a lens.

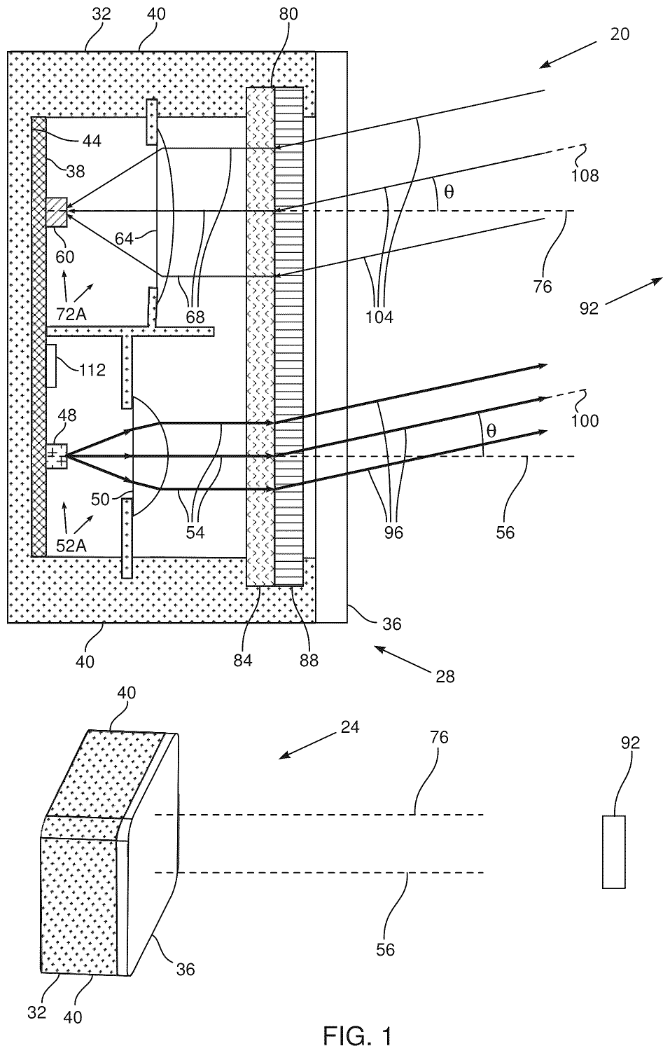

Reference is now made to FIG. 1, which shows schematic diagrams of a Time of Flight, Light direction and ranging (TOF LIDAR) system 20, herein also termed a ToF system 20, according to an embodiment of the present invention. FIG. 1 illustrates two views of system 20, an external view 24 and a cross-sectional view 28. As illustrated by view 24, system 20 is in the general form of a rectangular parallelepiped, but it will be understood that this form is by way of example, and that system 20 may be implemented in other forms, such as cylindrical, and all such forms are assumed to be comprised within the scope of the present invention. In one disclosed embodiment the rectangular parallelepiped has sides that are approximately 1 mm in length, but other embodiments may have sides that are smaller or larger than 1 mm.

System 20 comprises an external, generally cup-shaped, support structure 32, which is configured to fixedly retain the elements, described below, of the system. In the example illustrated, one side of structure 32 is open, and a transparent cover plate 36 closes the structure by being fixedly attached to walls 40 of structure 32.

A planar substrate 38 is fixedly attached internally to a base 44 of structure 32, and the substrate retains a light radiator 48, herein assumed to comprise a solid-state laser, that is also referred to as laser 48. Laser 48 may be configured to radiate linearly polarized outgoing light in the visible or non-visible spectrum and in a disclosed embodiment the wavelength is in the near infra-red. Outgoing light from radiator 48 is received by a lens 50, which is fixed within structure 32 so as to collimate the received light. Radiator 48 and collimating lens 50 act as a light transmitter 52A, transmitting collimated light 54 along and parallel to a transmit axis 56. Radiator 48 is at a focus of collimating lens 50, and axis 56 is orthogonal to substrate 38 and passes through the radiator.

Substrate 38 also retains s a photo detector 60, typically an avalanche photo detector, alongside radiator 48. A focusing lens 64 is fixed internally within structure 32 and is configured to focus incoming parallel light 68 to detector 60, which lies at a focus of the lens. Lens 64 and detector 60 act as a light receiver 72A that has a receive axis 76, parallel to transmit axis 56, and incoming parallel light 68 travels parallel to and along the receive axis. Receive axis 76 is orthogonal to substrate 38 and passes through detector 60.

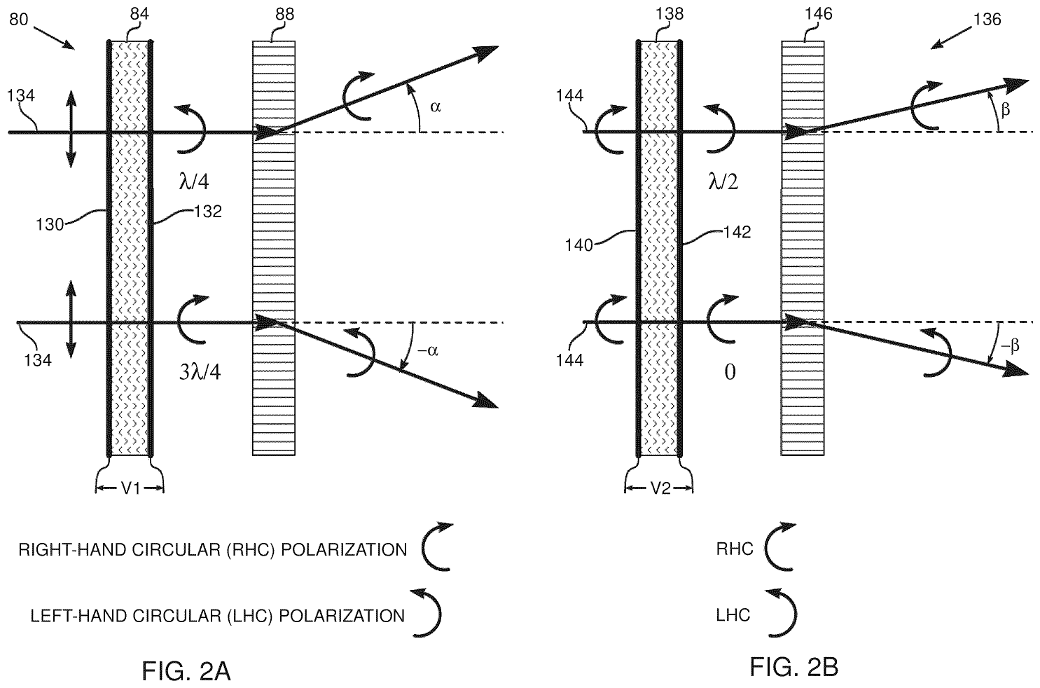

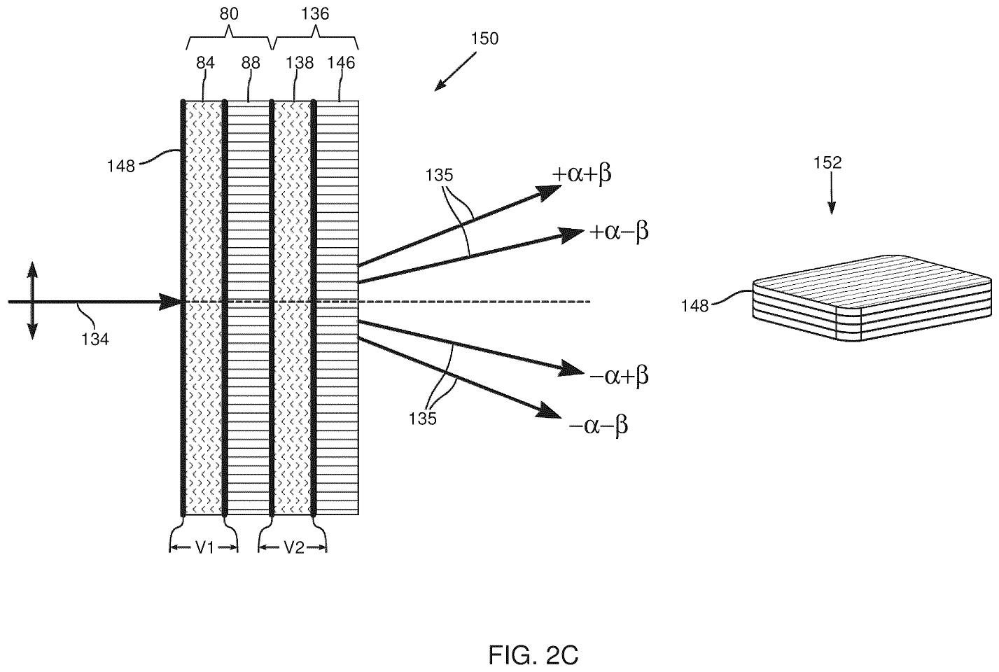

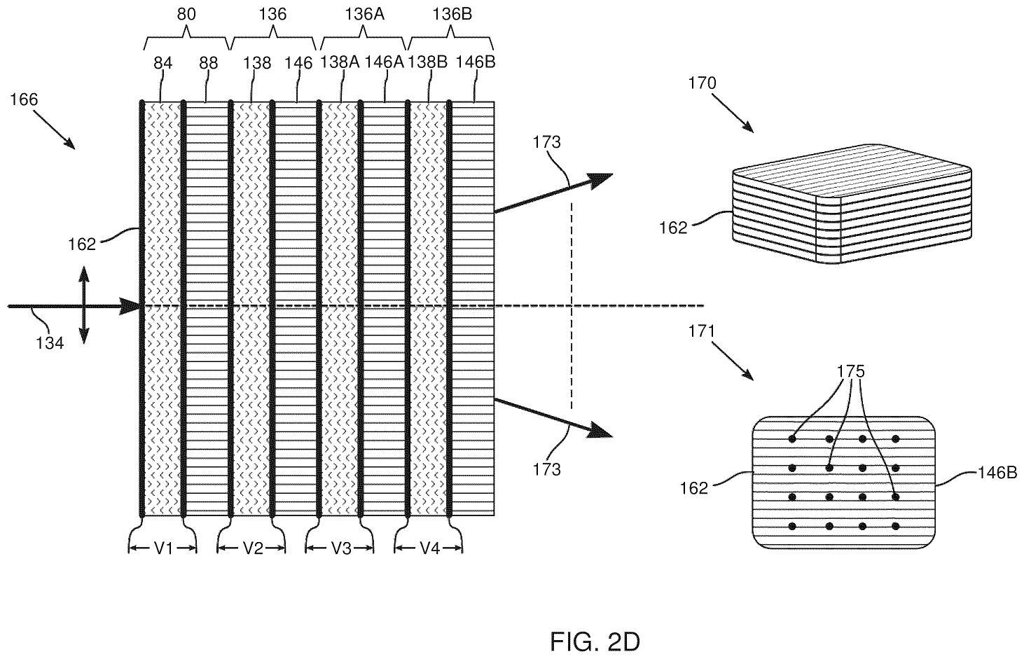

A switchable planar liquid crystal polarized grating (LCPG) 80, also herein termed a grating assembly 80 or a switchable LCPG assembly 80, is fixed within structure 32 so that it is orthogonal to transmit and receive axes 56 and 76. Grating assembly 80 is formed of a switchable liquid crystal (LC) plate 84 butted to a polarization grating (PG) plate 88 and its operation, as well as the operation of alternative switchable LCPGs, is described in more detail below, with respect to FIGS. 2A-2D. As described therebelow, depending on the switched state of LC plate 84, assembly 80 diverts incoming parallel light by one of two predetermined angles. The diversion is the same, regardless of the side of assembly 80 upon which the parallel light is incident.

FIG. 2A is a schematic diagram of a cross-section of grating assembly 80, according to an embodiment of the present invention. As stated above, assembly 80 is formed by butting switchable LC plate 84 to PG plate 88, and in the figure the two plates are illustrated as separate to illustrate how the assembly functions.

LC plate 84, typically formed from a twisted nematic liquid crystal, has a pair of transparent electrodes, 130 and 132 on opposite sides of the plate. In an embodiment electrodes 130 and 132 are formed from indium tin oxide (ITO). LC plate 84 is configured as a switchable quarter wave plate, so that, depending on the voltage V1 applied between electrodes 130 and 132, incoming light is retarded by a quarter of a wavelength, λ/4, where λ is the light wavelength, or by three-quarters of a wavelength, 3λ/4. In system 20 voltage V1 is applied by controller 112.

The figure shows two beams 134 of incoming linearly polarized light to LC plate 84, such as that received from laser 48. As illustrated in the upper part of the figure, when plate 84 provides a quarter wavelength retardation, the linearly polarized light is converted to left-hand circularly (LHC) polarized light. As illustrated in the lower part of the figure, when plate 84 provides three-quarters wavelength retardation, the linearly polarized light is converted to right-hand circularly (RHC) polarized light.

The circularly polarized light transfers to PG plate 88. In embodiments of the present invention, the polarization grating is assumed to be a passive object comprising plane half wave plates, having a spatially varying optical anisotropy wherein the anisotropy axis angular direction varies linearly with the lateral direction to form a grating which diffracts the light along that spatial direction. This is also known as a Pancharatnam-Berry grating.

Depending on the handedness of the received circularly polarized light PG plate 84 diverts the incoming beam by either +α or −α, where the value of a has a predetermined angular value that is a function of the period of the polarization grating of plate 88, and of the incoming wavelength λ. PG plate 84 also changes the handedness of circularly polarized light.

The upper part of the figure illustrates that LHC light is diverted by +α and becomes an RHC beam. The lower part of the figure illustrates that RHC light is diverted by −α and becomes an LHC beam.

FIG. 2B is a schematic diagram of a cross-section of a pair 136 of plates, comprising an LC plate and a PG plate, that may be used to form other grating assemblies, according to an embodiment of the present invention. The figure illustrates a switchable LC plate 138 that is generally similar to LC plate 84, having electrodes 140 and 142 on opposite sides of the plate. However LC plate 138 is configured, depending on a voltage V2 applied to the electrodes, to operate as a switchable half-wave plate,

$$( \frac{λ}{2} )$$

providing either zero retardation or a half-wave retardation. LC plate 138 is also referred to herein as switchable half-wave plate 138.

When operating to provide half-wave retardation, plate 138 changes the handedness of incoming circularly polarized light, as illustrated by the upper section of the figure, where a right-handed beam 144 is changed to a left-handed beam. When there is no retardation there is no change in handedness, as illustrated by the lower section of the figure, where the right-handed beam 144 remains right-handed.

While in operation plate 138 is butted to a PG plate 146, the figure shows the two plates separated to illustrate the operation of pair 136. PG plate 146 is substantially similar in function and operation to PG plate 88, but may have a different grating period, so as to have a different predetermined diversion angle β. Thus, the upper part of the figure illustrates that LHC light is diverted by +β and becomes an RHC beam. The lower part of the figure illustrates that the RHC beam is diverted by −β and becomes an LHC beam.

FIG. 2C is a schematic diagram of an alternative grating assembly 148, according to an embodiment of the present invention. Assembly 148 is shown with two views, a cross-sectional view 150, and a perspective view 152. Grating assembly 148, also herein termed switchable LCPG assembly 148, is formed by butting a pair of elements 136 to grating assembly 80, to form a stack of four plates. In forming grating assembly 148, the linear gratings of PG plates 88 and 146 are arranged to be parallel.

When linear polarized light, such as beam 134, is incident on assembly 148, then, depending on the voltages V1 and V2 applied to the assembly, there are four possible diverted beams 135, the beams making approximate angles, assuming angles α and β are small, of (+α+β), (+α−β), (−α+β), (−α−β) with the incoming beam. The diverted beams 135 all lie in one plane, corresponding to the plane of the paper. Each diverted beam 135 is also circularly polarized.

As is illustrated in the figure, LC plates 84 and 138 and PG plates 88 and 146 are butted together in alternation.

FIG. 2D is a schematic of diagram a further alternative grating assembly 162, according an to embodiment of the present invention. Assembly 162 is shown with three views, a cross-sectional view 166, a perspective view 170, and a top-down view 171. Cross-sectional view 166 illustrates linearly polarized light 134 as being incident on assembly 162.

Grating assembly 162, also herein termed switchable LCPG assembly 162, is formed by butting pairs of elements 136A, 136B, substantially similar to pair 136, to pair 136 and to grating assembly 80, to form a stack of eight plates. Pair 136A and pair 136B have respective switchable half-wave LC plates 138A, 138B, that are substantially similar to switchable half-wave LC plate 138, described above, and that are respectively operated by voltages V3 and V4.

Pair 136A and pair 136B also have respective PG plates 146A, 146B, that are substantially similar to PG plate 146, although they may have different grating spacings. The linear gratings of PG plates 146A and 146B are configured to be parallel to each other. However, in assembly 162, the directions of the linear gratings of PG plates 146A and 146B are configured to be orthogonal to the directions of the linear gratings of PG plates 88 and 146.

By having the gratings of PG plates 146A and 146B orthogonal to those of plates 88 and 146, each of the four beams 135 exiting from plate 146 (as illustrated in FIG. 2C) is itself diverted to one of four directions, depending on the voltages V3 and V4, giving a total of 16 beams 173 (for clarity, only two diverted beams 173 are shown in view 166). Because of the orthogonality of the gratings, under a small angle approximation, the beams diverted from beams 135 are in a plane orthogonal to the plane of the four beams 135, i.e., in a plane orthogonal to the plane of the paper. Thus, as illustrated in view 171, the exit locations 175 of the 16 beams 173 from plate 146B are arranged in a two-dimensional 4×4 grid. The 16 beams 173 are all circularly polarized.

As is illustrated in the figure, the LC plates and the PG plates of assembly 162 are butted together in alternation.

For simplicity, each ToF system described herein has been illustrated using switchable LCPG assembly 80. It will be understood that each ToF system may use alternative switchable LCPGs, such as assembly 148, assembly 162, or other switchable LCPGs that may be constructed from pairs of LC and PG plates such as pair 136, and those having ordinary skill in the art will be able to adapt the description, mutatis mutandis, for such alternative switchable LCPGs. All such alternative LCPGs are assumed to be comprised within the scope of the present invention.

Returning to FIG. 1, outgoing linearly polarized collimated light 54 is shown as being diverted by assembly 80 by an angle θ, towards a target 92. Thus, assembly 80 intercepts light 54, and diverts the light to travel, as a beam 96, along a diverted transmit axis 100 subtending an angle θ with axis 58. As explained above with reference to FIG. 2A, beam 96 is circularly polarized.

Similarly, an incoming parallel light beam 104, that travels along and parallel to an initial receive axis 108, and that subtends an angle θ with receive axis 76, is intercepted by assembly 80 and the polarization component with the appropriate circular polarization (which contains half the energy of beam 104) is diverted by the assembly by angle θ from its initial receive axis to form parallel light 68 traveling along and parallel to receive axis 76.

System 20 is operated by a controller 112, which in one embodiment comprises circuitry located on substrate 38. However, system 20 may be operated by any other convenient controller. For example, if system 20 is installed in a smartphone, a controller associated with the smartphone may be used to operate the system.

To operate system 20 controller 112 is connected to radiator 48, detector 60, and LC plate 84. In a typical operation of the system, controller 112 initially switches LC plate 84 so that grating assembly 80 diverts incoming parallel light by a selected angle. Controller 112 then pulses radiator 48 to radiate a light beam to lens 64, and registers the time when the radiator is pulsed. The beam travels towards target 92, as described above for beam 96. Controller 112 accesses detector 60 and records electrical signals generated by the detector, in response to a returning beam from the target, as described above for beam 104. The recordation includes a received time at which the returning beam arrives at the detector.

From the registered time at which radiator 48 is pulsed and the received time at detector 60 controller 112 may determine a time of flight of the beam transmitted from the radiator, and thus the distance from system 20 to target 92. However, it will be understood that controller 112 may use the recorded electrical signals to determine other properties of the target, such as its reflectivity, transparency, or color, and all such properties are included in the scope of the present invention.

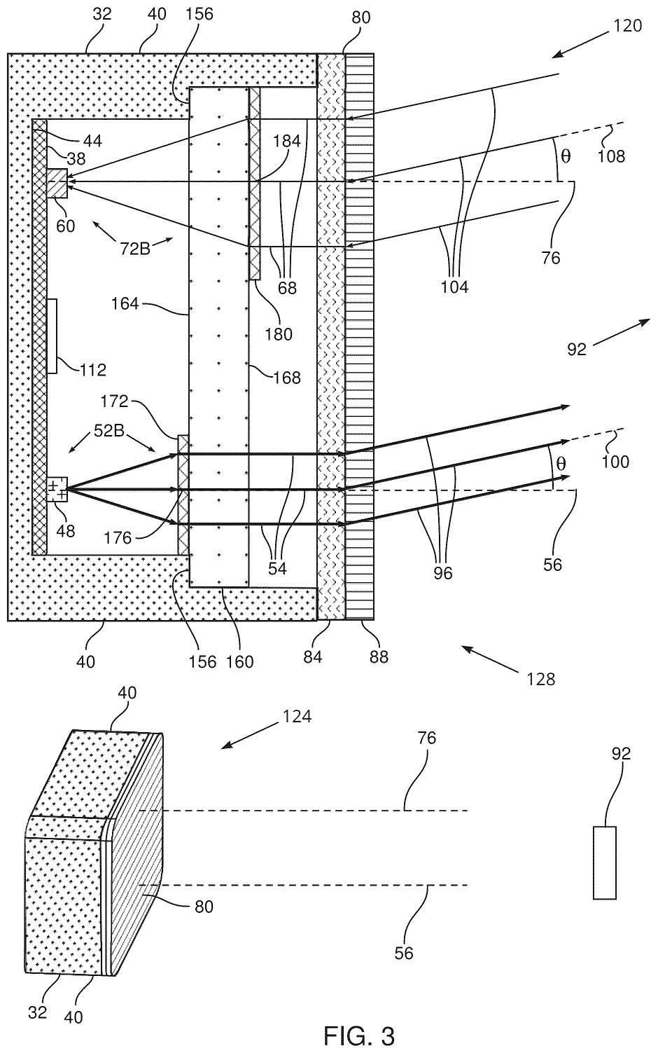

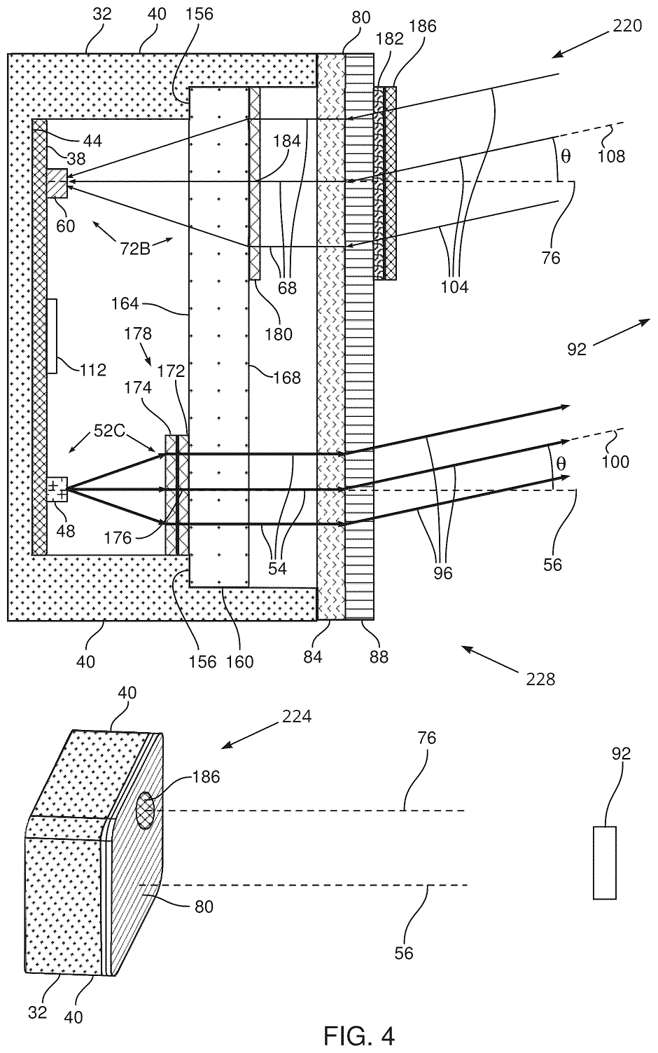

FIG. 3 shows schematic diagrams of a ToF system 120, according to an alternative embodiment of the present invention. FIG. 3 illustrates two views of system 120, an external view 124 and a cross-sectional view 128. Apart from the differences described below, the operation of system 120 is generally similar to that of system 20 (FIG. 1), and elements indicated by the same reference numerals in both systems 20 and 120 are generally similar in construction and in operation.

As for system 20, system 120 comprises a planar LCPG 80; however, in system 120 LCPG 80 is used to close structure 32, in place of cover plate 36, by being fixedly attached to walls 40 of the structure. LCPG 80 is attached to walls 40 so that it is parallel to substrate 38, and so that it is orthogonal to axes 56 and 76.

In contrast to system 20, system 120 does not use collimating lens 50 or focusing lens 64, but replaces these elements by respective optical metasurfaces, also herein termed meta-optical elements (MOEs), which have a planar structure composed of subwavelength-sized artificial features, and which are described below.

Thus, mounted internally in structure 32, on internal shoulders 156 of walls 40, is a planar transparent plate 160. Plate 160, typically formed of glass, has a first side 164 and a second side 168 parallel to the first side, both sides being formed as planes that, by virtue of their mounting on shoulders 156, are orthogonal to axes 56 and 76 and so are parallel to substrate 38. First side 164 is proximal to substrate 38, and second side 168 is distal to the substrate.

A first planar metasurface 172 is formed on first side 164, and so is orthogonal to axis 56 and proximate to laser 48. The metasurface is configured to operate as a collimating lens for light emitted from laser 48, having a focus at the laser location and an optical center 176. Laser 48 and metasurface 172 act as a light transmitter 52B, performing substantially the same function as transmitter 52A, e.g., transmitting collimated light 54 along and parallel to transmit axis 56.

A second planar metasurface 180 is formed on second side 168, and so is orthogonal to axis 76. The metasurface, together with transparent plate 160, is configured to operate as a focusing lens, focusing incoming light, parallel to axis 76, to light detector 60. I.e., metasurface 180 performs the same function as focusing lens 64, having a focus at the light detector location, and an optical center 184 that lies on axis 76. Metasurface 180 and detector 60 act as a light receiver 72B, performing substantially the same function as receiver 72A. Positioning metasurface 180 on second side 168, distal from detector 60, maximizes the aperture size of receiver 72B for collecting light photons.

As is the case for system 20, in system 120 LCPG 80 is orthogonal to axes 56 and 76, and performs the same function as in system 20, i.e., diverting incoming parallel light by one of two predetermined angles. Thus, outgoing collimated light 54 is diverted by LCPG 80 by angle θ, towards target 92 along axis 100. In addition, incoming parallel light beam 104, that travels along and parallel to receive axis 108, which subtends angle θ with receive axis 76, is intercepted by LCPG 80 and is diverted by the LCPG by angle θ from the receive axis to form parallel light 68 traveling along and parallel to receive axis 76.

System 120 also comprises controller 112, which performs the same functions for system 120 as those described above for system 20. Thus, as for system 20, controller 112 in system 120 controls elements of system 120 and may determine properties of target 92.

FIG. 4 shows schematic diagrams of a ToF system 220, according to a further alternative embodiment of the present invention. FIG. 4 illustrates two views of system 220, an external view 224 and a cross-sectional view 228. Apart from the differences described below, the operation of system 220 is generally similar to that of system 120 (FIG. 3), and elements indicated by the same reference numerals in both systems 120 and 220 are generally similar in construction and in operation.

In system 220, rather than a single metasurface 172 that is used as a collimating lens for laser 48, system 220 uses a plurality 178 of metasurfaces. FIG. 4 illustrates, as an example of the plurality, a second metasurface 174, proximate to metasurface 172, that is orthogonal to axis 56. However, it will be understood that plurality 178 may comprise more than two metasurfaces.

Laser 48 and the plurality 178 of metasurfaces act as a light transmitter 52C, performing substantially the same function as transmitters 52A and 52B.

In some embodiments plurality 178 may be configured to operate as a telecentric lens. Alternatively or additionally, plurality 178 may be easily configured to reduce the divergence of the parallel rays exiting from transmitter 52C, down to a diffraction limit, due to the limited field of illumination.

System 220 comprises receiver 72B, described above with reference to system 120. However, in system 220 a circular polarizer 182 is positioned on the external face of assembly 80, in the receive path of system 220. Circular polarizer 182 acts to filter out the polarization component that is not going to be focused on detector 60, in order to avoid stray light/noise.

To further enhance the efficiency of receiver 72B, a notch filter 186, selected to correspond to the wavelength transmitted by laser 48 and to reject ambient light, is placed in the receive path. As illustrated in the figure, notch filter 196 may be positioned on polarizer 182.

In system 220 LCPG 80 and controller 112 perform the same functions as for system 120.

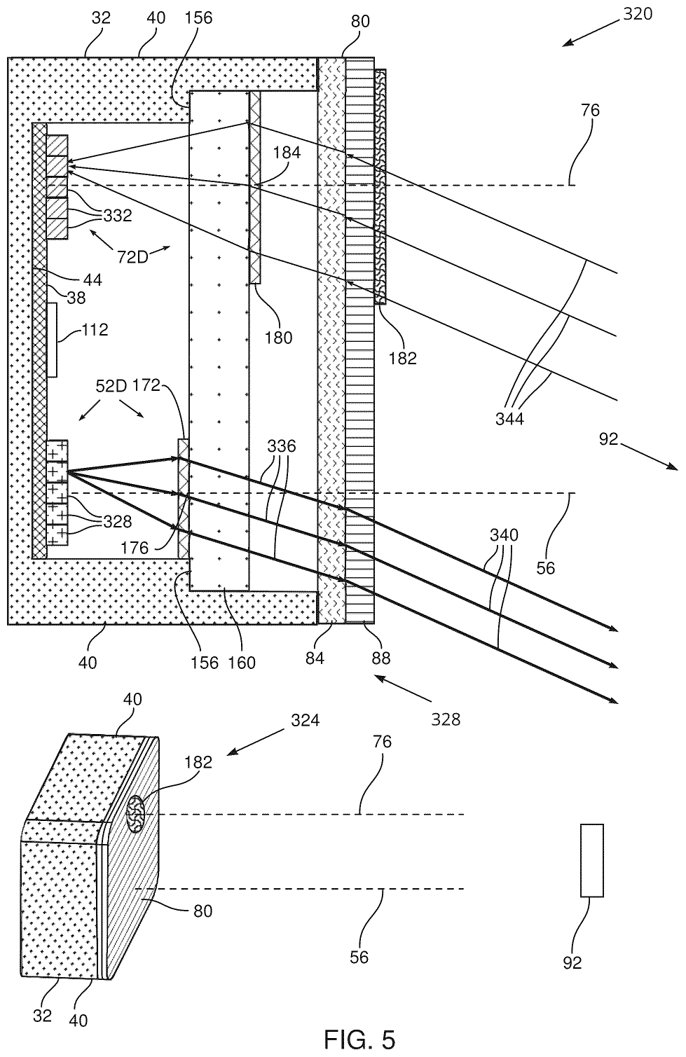

FIG. 5 shows schematic diagrams of a ToF system 320, according to a yet further alternative embodiment of the present invention. FIG. 5 illustrates two views of system 320, an external view 324 and a cross-sectional view 328. Apart from the differences described below, the operation of system 320 is generally similar to that of systems 120 and 220 (FIG. 3 and FIG. 4), and elements indicated by the same reference numerals in systems 120, 220, and 320 are generally similar in construction and in operation.

In contrast to systems 120 and 220, which have a single radiator, laser 48, and a single photo detector, detector 60, system 320 comprises a first multiplicity of substantially similar radiators 328 and a second multiplicity of substantially similar detectors 332. Radiators 328 together with metasurface 172 act as a light transmitter 52D, and detectors 332 together with metasurface 180 act as a light receiver 72D.

In an embodiment radiators 328 of transmitter 52D radiate linearly polarized light and are formed as a two-dimensional (2D) array, located on substrate 38, that is orthogonal to axis 56, and that is generally centered on the axis. In one embodiment each radiator comprises a vertical cavity surface emitting laser (VCSEL).

Detectors 332 of receiver 72D may also be formed as a 2D array, located on substrate 38, that is orthogonal to axis 76 and that is generally centered on the axis. In one embodiment each detector 332 comprises a single photon avalanche detector (SPAD).

In contrast to system 120, wherein the one radiator 48 lies on axis 56, the array of radiators 328 comprises radiators that are not on axis 56. Metasurface 172 converts the light from respective radiators 328 to respective collimated beams, but it will be understood that collimated beams originating from off-axis radiators 328 are not parallel to axis 56. After diversion by assembly 80 the collimated beams are also not parallel to axis 56.

One such collimated beam 336 to target 92, originating from an off-axis radiator 328, is schematically drawn in FIG. 5, illustrating that neither it, nor a diverted beam 340 formed from it by assembly 80, are parallel to axis 56. It will be understood that providing an array of radiators 328, and using the array with assembly 80, broadens the field of view of system 320, i.e., the size of the region radiated into, compared to the field of view of systems 120 and 220.

FIG. 5 also illustrates an incoming light beam 344 from target 92, that is generally parallel to diverted outgoing beam 340. Incoming light beam 344, after traversing polarizer 182, is diverted by assembly 80 by the same diversion angle as the angle between radiation beams 338 and 340. The diverted beam is focused by metasurface 180 to a detector 332 that is not on axis 76. The diversion provided by assembly 80 helps reducing off-axis aberration by decreasing the angle between the incoming rays and axis 76.

It will be appreciated that the embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. A system for optical sensing, comprising:
a transmitter, configured to transmit outgoing collimated light toward a target along a transmit axis;
a receiver, positioned alongside the transmitter and configured to receive incoming light propagating from the target along a receive axis parallel to the transmit axis and to output electrical signals in response to the received incoming light;
a switchable liquid crystal polarized grating (LCPG) positioned to intercept and divert, by a common angle, both the outgoing collimated light along the transmit axis and the incoming light along the receive axis, the common angle being selectable from among a plurality of preset diversion angles of the LCPG; and
a controller configured to switch the LCPG over the preset diversion angles and to process the electrical signals output by the receiver in response to the incoming light received at the preset diversion angles so as to sense a property of the target.

2. The system according to claim 1, wherein the transmitter comprises a single radiator that radiates light to a metasurface, and wherein the metasurface is configured to produce the collimated light.

3. The system according to claim 1, wherein the receiver comprises a single detector that receives light from a metasurface, and wherein the metasurface is configured to focus the incoming light to the single detector.

4. The system according to claim 1, wherein the switchable LCPG comprises a passive polarization grating (PG) plate butted to a switchable liquid crystal (LC) plate configured to provide a switchable retardation to the outgoing collimated light and the incoming light.

5. The system according to claim 4, wherein the switchable retardation is one of a quarter-wave retardation and a three quarter-wave retardation.

6. The system according to claim 4, wherein the switchable retardation is one of a half-wave retardation and a zero retardation.

7. The system according to claim 1, and comprising a planar transparent plate having a first side, comprising a first metasurface configured to focus light to a detector in the receiver, and a second side, opposite the first side, comprising a second metasurface configured to form the outgoing collimated light in response to receiving light from a radiator in the transmitter.

8. The system according to claim 1, wherein the transmitter comprises a plurality of separate radiators, each radiator being configured to radiate light to a metasurface, comprised in the transmitter, so as to produce the outgoing collimated light.

9. The system according to claim 1, wherein the receiver comprises a plurality of separate detectors, each detector being configured to receive focused light from a metasurface, comprised in the receiver, configured to receive the incoming light.

10. The system according to claim 1, wherein the switchable LCPG comprises a plurality of switchable liquid crystal (LC) plates and the plurality of passive polarization grating (PG) plates, the LC plates and the PG plates being butted to each other in alternation.

11. The system according to claim 1, wherein the property of the target comprises a distance of the target from the system.

12. A method for optical sensing, comprising:
transmitting outgoing collimated light toward a target along a transmit axis;
receiving incoming light propagating from the target along a receive axis parallel to the transmit axis and outputting electrical signals in response to the received incoming light;
positioning a switchable liquid crystal polarized grating (LCPG) to intercept and divert, by a common angle, both the outgoing collimated light along the transmit axis and the incoming light along the receive axis, the common angle being selectable from among a plurality of preset diversion angles of the LCPG; and
switching the LCPG over the preset diversion angles and processing the electrical signals output by the receiver in response to the incoming light received at the preset diversion angles so as to sense a property of the target.

13. The method according to claim 12, and comprising providing a single radiator that radiates light to a metasurface, and wherein the metasurface is configured to produce the collimated light.

14. The method according to claim 12, and comprising providing a single detector that receives light from a metasurface, and wherein the metasurface is configured to focus the incoming light to the single detector.

15. The method according to claim 12, wherein the switchable LCPG comprises a passive polarization grating (PG) plate butted to a switchable liquid crystal (LC) plate configured to provide a switchable retardation to the outgoing collimated light and the incoming light.

16. The method according to claim 15, wherein the switchable retardation is one of a quarter-wave retardation and a three quarter-wave retardation.

17. The method according to claim 15, wherein the switchable retardation is one of a half-wave retardation and a zero retardation.

18. The method according to claim 12, and comprising providing a planar transparent plate having a first side, comprising a first metasurface configured to focus light to a detector in a receiver of the incoming light, and a second side, opposite the first side, comprising a second metasurface configured to form the outgoing collimated light in response to receiving light from a radiator in a transmitter of the outgoing collimated light.

19. The method according to claim 12, and comprising providing a transmitter having a plurality of separate radiators, each radiator being configured to radiate light to a metasurface, comprised in the transmitter, so as to produce the outgoing collimated light.

20. The method according to claim 12, and comprising providing a receiver having a plurality of separate detectors, each detector being configured to receive focused light from a metasurface, comprised in the receiver, configured to receive the incoming light.

21. The method according to claim 12, wherein the switchable LCPG comprises a plurality of switchable liquid crystal (LC) plates and the plurality of passive polarization grating (PG) plates, the LC plates and the PG plates being butted to each other in alternation.

22. The method according to claim 12, wherein the property of the target comprises a distance of the target from a system transmitting the outgoing collimated light.
